(19) United States
(12) Patent Application Publication
(10) Pub. No.: US 2025/0094241 A1
(43) Pub. Date: Mar. 20, 2025

(54) TECHNIQUES FOR MAINTENANCE-DOMAIN-AWARE VIRTUAL MACHINE PLACEMENT IN A CLOUD PLATFORM

(71) Applicant: Oracle International Corporation, Redwood Shores, CA (US)

(72) Inventors: Deepesh Lall, Redwood Shores, CA (US); Shashidhara Tadaga, Redwood Shores, CA (US); Nagarajan Muthukrishnan, San Ramon, CA (US)

(21) Appl. No.: 18/369,135

(22) Filed: Sep. 15, 2023

(51) Int. Cl. G06F 9/50; G06F 9/455

(52) U.S. Cl. CPC G06F 9/5088; G06F 9/45558; G06F 2009/4557

(57) ABSTRACT

Rolling maintenance involves partitioning the compute nodes of a host platform into multiple maintenance domains (MDs), and patching those MDs in a rolling fashion. Techniques are described herein for establishing the VM-to-compute-node placement in an “MD-aware” manner. Specifically, the VM-to-compute-node placement takes into account the MD-to-compute-node mapping, supports constraints and goals related to achieving the required levels of availability during rolling maintenance, and for any given customer, avoids having maintenance events (and corresponding notifications) at excessive frequencies.

### FIELD OF THE INVENTION

The present invention relates to cloud platforms and, more specifically, to techniques for placing virtual machines in compute nodes of a cloud platform in a manner that is maintenance-domain-aware.

### BACKGROUND

In many cloud environments, a cloud provider executes and manages virtual machines (VMs) on behalf of customers. The software used to execute and manage VM clusters is referred to as a “hypervisor”. The set of cloud-hosted VMs used by a given customer are referred to herein as the customer's “VM cluster”. The number of VMs in a customer's VM cluster varies from customer to customer, and is often determined by the customer. The cloud-based computing devices that execute the hypervisors and VM clusters of a cloud platform are referred to herein as “compute nodes”. In many situations, VM clusters are used for database systems.

FIG. 1A is a block diagram that depicts a cloud platform that hosts VMs for three customers C1, C2 and C3. The cloud platform has eight compute nodes (N1 to N8) for hosting the VMs of customers C1, C2 and C3. In the illustrated example, the VM cluster of customer C1 has four VMs (VM C1-1 to VM C1-4) that are to be hosted on the cloud platform. The VM cluster of customer C2 also has four VMs (VM C2-1 to VM C2-4) that are to be hosted on the cloud platform. The VM cluster of customer C3 has six VMs (VM C3-1 to VM C3-6) that are to be hosted on the cloud platform.

The cloud platform illustrated in FIG. 1A also has a VM-to-compute-node placement module 100. VM-to-compute-node placement module 100 generally represents the logic, used by the cloud platform, to determine which compute nodes will host which VMs. The performance of the cloud system is significantly impacted by the VM-to-compute node placements. For example, a bad placement of VMs to compute nodes will cause some compute nodes to be overburdened, while others remain underutilized. As another example, placing all of the VMs of a customer on a single compute node subjects that customer's VM cluster to a single point of failure. Thus, it is critical that the VM-to-compute node placement be performed intelligently in a manner that optimizes for multiple goals, such as load balancing, optimizing the use of resources available on the cloud platform, and reducing vulnerability to single points of failure.

A cloud platform that hosts the VM clusters of many customers is referred to as a “multi-tenant” cloud environment. In such an environment, patching the hypervisors on the compute nodes presents several difficulties. Specifically, it may not be possible for compute nodes to execute VM clusters normally during the hypervisor patching process. However, shutting down all compute nodes for hypervisor patches/upgrades is not feasible because cloud providers are often bound by contract to maintain high availability under Service Level Agreements (SLAs). Maintaining high availability for provisioned VM clusters during the hypervisor patching process is even more difficult when the VM clusters are used for database systems.

One approach to maintaining availability during the hypervisor patching process involves logically partitioning the compute-nodes of the cloud platform. Such partitions, referred to herein as Maintenance Domains (MDs), are typically non-overlapping (i.e. any given compute node belongs to no more than one MD). The number of MDs into which the compute-nodes of the cloud platform are partitioned is typically determined by that administrators of the cloud platform. FIG. 1B is a block diagram in which the compute nodes shown in FIG. 1A have been partitioned into four maintenance domains (MD1-MD4).

Once the compute nodes of a cloud platform have been partitioned in this manner, the patching of hypervisors can be performed in a rolling fashion. Patching the compute nodes on a per-MD basis in this manner is referred to herein as “rolling maintenance”. For example, during a first time period, the compute nodes (N1, N2) of MD1 may be patched. Then, during a second time period the compute nodes (N3, N4) of MD2 are patched, then during a third time period the compute nodes (N5, N6) of MD3 are patched, and so on until eventually all of the compute nodes have been patched. Then the maintenance window rolls back to the compute nodes of MD1 for the next round of patching.

Typically, patching the hypervisor on a compute node requires all of the VMs on the compute node to be shut down (“drained”). Draining a compute node may involve migrating the VMs that are on the compute node to a compute node that has already been upgraded. Thus, during any given time period of rolling maintenance, the compute nodes of one MD are:
being drained of VMs, and
then patched.

The MD whose compute nodes are currently being drained of VMs and then patched is referred to herein as the “current MD”. Because rolling maintenance involves temporary downtime for the VMs on the compute nodes of the current MD, it is desirable to obtain customer consent before the customer's VMs are drained/migrated. Ideally, customers should be given a notification to choose the time under a fixed window (“notification period”) for the maintenance. For example, the cloud platform may give a particular customer a two-week notice that the compute nodes that belong to a particular MD are going to be patched. The customer may then decide when, before the end of that two week period, the customer's VMs in that particular MD can be drained/migrated. Once all the VMs of a particular hypervisor have been drained, the patch of that hypervisor is performed. If any VMs that are running on the compute nodes of the current MD have not been drained/migrated by the end of the maintenance window for the current MD, those VM may be forced to migrate so that the patching process for the compute-nodes within the current MD may proceed.

In cloud systems that perform rolling maintenance, an intelligent placement of virtual machines among the compute nodes is critical to ensure that performance loss caused by the rolling maintenance does not violate any customer's policy. Further, the VM-to-compute-node placement should be such that the frequency of maintenance events (and corresponding maintenance notifications) does not unduly negatively impact the customer experience. The VM-to-compute-node placement should also balance distribution in a manner that facilitates the fixing problems, including those that may require manual intervention.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1A is a block diagram of a cloud platform;

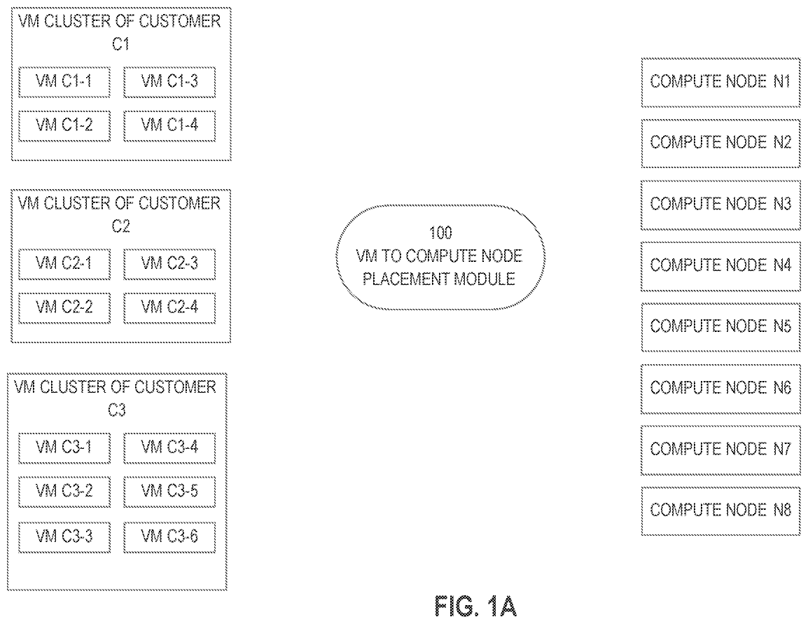

FIG. 1B is a block diagram of a cloud platform in which the compute nodes have been partitioned into maintenance domains;

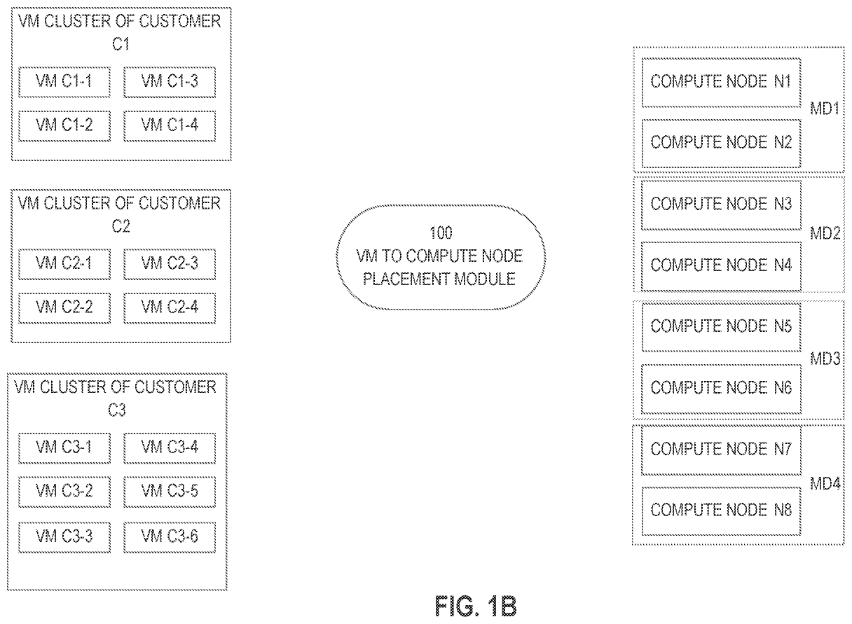

FIG. 2 is a flowchart illustrating general steps for determining the compute node on which to place a target VM, according to an embodiment;

FIG. 3 illustrates an objective function for selecting the compute node for a target VM, according to an implementation; and

FIG. 4 is a block diagram of a computer system that may be used to implement the MD-aware VM-to-compute-node placement techniques described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

As explained above, rolling maintenance involves partitioning the compute nodes of a host platform into multiple MDs, and patching those MDs in a rolling fashion. Because the VMs of the current MD experience downtown when drained/migrated, the VM-to-compute-node placement must be done intelligently to ensure each customer experiences their required levels of availability and service. Consequently, techniques are described herein for establishing the VM-to-compute-node placement in an “MD-aware” manner. Specifically, the VM-to-compute-node placement:
takes into account the MD-to-compute-node mapping
supports constraints and goals related to achieving the required levels of availability during rolling maintenance
for any given customer, avoids having maintenance events (and corresponding notifications) at excessive frequencies.

Specifically, described hereafter is an MD-aware VM-to-compute-node placement algorithm that places the VMs of the VM-Cluster of each customer on each compute node as per a policy, selected by the customer, to maintain a high availability and good customer experience with minimal and optimal scope for manual intervention of operations.

In general, the placement logic performs an optimization search by minimizing a weighted average of an objective function, where the objective function has specific quantifiable metrics that correspond to the goals for which optimization is sought. As shall be described in detail hereafter, to account for MD-related goals during the optimization, the objective function used in the VM-to-compute-node placement logic includes both MD-aware metrics (e.g. metrics for equalizing the spread VMs across MDs, for equalizing the spread a given customer's VMs across MDs, and for avoiding too-closely-timed maintenance events for a given customer) and non-MD-aware metrics (e.g. resource optimization metrics).

### Terminology

During the following discussion of MD-aware placement techniques, the following terms shall be used:
“target VM”—the VM for which a placement is currently being computed.
“target VM cluster”—the VM cluster to which the target VM belongs.
“Maintenance Period”—the duration within which all nodes in the cloud platform should be patched to a next level. The maintenance period of a cloud platform may be, for example, 90 days. In the case of a 90 day maintenance period, the 90 days must include the maintenance windows for each of the MDs of the cloud platform.
“Maintenance Policy”—the policy associated with a customer's VM cluster which defines the maintenance strategy for the VMs of the cluster.
“vmClusterMdAvgDistance”—average distance between the MDs of the compute nodes that are hosting the VMs of the target VM cluster (defined per-VM-cluster)
“mdMigrationDistance”—Distance of MDs where VMs should be migrated as part of maintenance. (Defined per-cluster per-MD).
“mdClusterDensity”—the ratio of the number of VMs of a cluster in the MD to the total number of VMs of the cluster. (defined per-cluster per-MD).
“mdVMDensity”—the ratio of the number of VMs in the MD to the number of VMs on the cloud platform (defined per-MD)

### Constraints and Goals

According to one implementation, VM-to-compute-node placement is performed by placement module 100 based on a set of constraints and a set of goals. Constraints are VM-to-compute-node placement rules with which each VM placement must comply. Thus, if placing VM C1-4 on compute node N1 would violate a constraint, then node N1 is eliminated as a candidate for hosting VM C1-4.

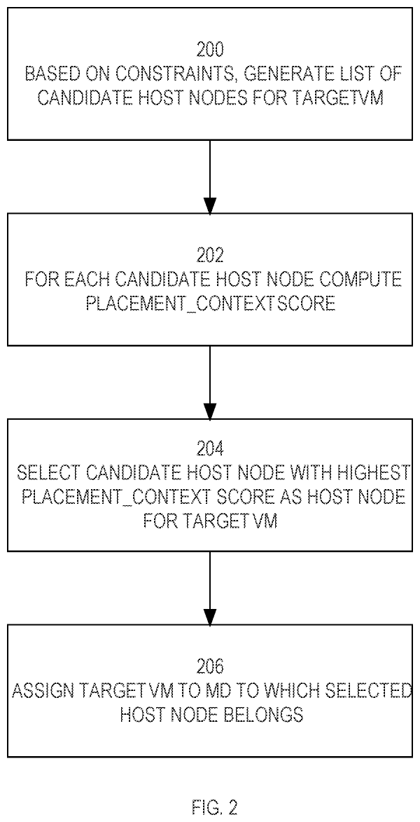

Goals, on the other hand, are metrics that are used to determine the “optimal” placement for a VM from among the compute nodes that remain as candidates (after the candidate set has been pruned based on the constraints). FIG. 2 is a flowchart showing the general steps for placing a “target VM” on a compute node of a cloud platform according to one implementation. Referring to FIG. 2, at step 200 based on the applicable constraints, the placement module 100 generates a list of candidate host nodes for target VM. At step 202, for each candidate host node, the placement module 100 computes a placement_context score for the target VM. At step 204, the placement module 100 selects the candidate host node with highest placement_context score as host node for the target VM. In step 206, the cloud platform hosts the target VM at the selected host node, thereby placing the target VM in the MD to which selected host node belongs.

For a MD-aware placement of VMs, the goals used to find the optimum placement of a target VM include one or more goals that relate to the MD to which a candidate compute node resides. As shall be described in greater detail hereafter, the MD-aware metrics for such MD-aware goals may include a “mdClusterDensity” metric associated with the goal of increasing the availability of a customer's VMs by spreading the VMs among several MDs, and a “vmClusterMdAvgDistance” metric associated with the goal of decreasing the frequency of maintenance-related notifications that a customer will receive. In addition to these metrics, the placement module 100 supports a “maintenancePolicy” parameter whose value for any given customer may establish an MD-aware constraint on the placement of that customer's VMs.

As shall be described in greater detail hereafter, a VM-to-compute-node placement technique is provided which accounts for a set of constraints, such as:
the VMs of a customer's VM cluster should be placed according to the maintenance policy specified by the customer
a newly created VM or migrated VM should be placed on nodes at a higher or latest patch level
during VM migration, the node to which a VM is migrated should be of similar hardware configuration as specified in the VM cluster definition

as well as attempts to achieve a set of goals, such as:
maximize VM spread (minimize standard deviation of resource usage of VMs on all compute-nodes in the cloud platform)
try to reach optimum VM resource density for each node
for each VM cluster, optimize towards average cluster MD distance so that the VMs of the VM cluster are placed equidistant with respect to maintenance windows
for each VM cluster, optimize towards having an equal number of VMs per MD to increase availability
for the entire VM population, optimize towards having an equal number of VMs per MD, to have an equal amount of patching during each maintenance window
   The maintenancePolicy Parameter: Balancing Availability with Maintenance Event Frequency

In one implementation, a ‘maintenancePolicy’ parameter is provided to enable each customer to select a policy regarding how the cloud platform maintains and manages their VMs' maintenance schedule. The maintenancePolicy parameter reflects a customer's preferred balance between availability and maintenance event frequency. Specifically, the greater the number of MDs to which the customer's VMs are assigned, the higher the availability (the fewer the number of the customer's VMs will be down during any given maintenance window) but also the higher the frequency of maintenance events (and notifications) experienced by the customer. For example, if each customer C1's four VMs is assigned to a compute node of a different MD, then customer C1 will only have one VM down at a time, but will experience a maintenance event in every maintenance window. Conversely, the lower the number of MDs to which the customer's VMs are assigned, the lower the availability but also the lower the frequency of maintenance events (and notifications) to the customer. Thus, if all of customer C1's VMs are assigned to compute nodes in M1, then all of the VMs will be down during the maintenance window of M1, but customer C1 would only experience on maintenance event per maintenance period.

In one implementation, the value for this parameter can be 1, 2, or 3. The value of 1 for the maintenancePolicy indicates that all of the customer's VMs are to be assigned to compute nodes in the same MD. Thus, the value of 1 for this parameter indicates that the customer prefers a single 100% downtime of their VM cluster in each maintenance period, rather than spread their VMs over the compute nodes in multiple MDs.

The value of 2 for the maintenancePolicy implies the customer prefers having up to 2 temporary downtimes during each maintenance period. For example, the VMs of such a customer may be split between compute nodes on MD1 and the compute nodes of MD3. During the maintenance window of MD1, the customer's VMs on compute nodes in MD3 will continue to operate. During the maintenance window of MD3, the customer's VMs on compute nodes in MD1 will continue to operate. Because maintaining availability is so important, maintenancePolicy 2 may be established as the default policy.

The value of 3 for the maintenancePolicy indicates that a customer prefers that the customer's VMs be spread across many MDs (not limited to 2). A maintenancePolicy 3 minimizes the number of VMs of a customer that will be down concurrently during any given maintenance period. However, maintenancePolicy 3 has the downside of increasing the frequency at which the customer will receive maintenance notifications.

The mdClusterDensity Metric: Increasing Availability During Maintenance

To address the issue of high availability for the customer's VM Cluster, the VM-to-compute-node placement should distribute the VMs of a customer in separate MDs so that when the compute node hosting some VMs of a customer goes into maintenance, the temporary downtime of those VMs gets handled by the customer's VMs that belong to the compute nodes in other MDs. This goal is quantified by a ‘mdClusterDensity’ metric. The value of the mdClusterDensity metric for a target VM cluster is defined for each MD, and represents the number of VMs of the target VM cluster that belong the MD compared to the total number of VMs of the VM cluster.

For example, if all of the VMs of the target VM cluster are placed on compute nodes in the same MD, the mdClusterDensity of that MD would be 1, and the mdClusterDensity of all other MDs would be zero. On the other hand, if the VMs of the target VM cluster are spread evenly among the MDs, then the mdClusterDensity for all MDs will be approximately the same. The more evenly a customer's VMs are spread among the MDs, the less likely a customer will have an unacceptably high performance degradation during any given maintenance window.

The vmClusterMdAvgDistance Metric: Avoiding Exposing a Customer to Too-Closely-Timed Maintenance Events

To maintain the high availability for customers opting for policies 2 or 3, it is important to maintain a good customer experience by placing VMs in a manner that avoids exposing a customer to “too-closely-timed” maintenance events. Stated another way, it is ideal that the maintenance events that affect a given customer occur at balanced intervals in each maintenance period. This goal is reflected in the metric ‘vmClusterMdAvgDistance’.

As indicated above, the vmClusterMDAvgDistance metric is average distance between the MDs of the compute nodes that are hosting the VMs of the target VM cluster. The smaller vmClusterMdAvgDistance of a target VM cluster, the more likely a customer will have less time than desired between successive maintenance events.

For example, assume that VM C1-1 to VM C1-2 are placed on compute nodes in MD1, and VM C1-3 and VM C1-4 are placed on compute nodes in MD2. In this scenario, customer C1 would receive maintenance notifications to drain/migrate VM C1-1 and VM C1-2 in the maintenance window for M1, and in the very next maintenance window (for M2) receive maintenance notifications to drain/migrate VM C1-3 and VM C1-4. The nearness of these maintenance events may be undesirable to customer C1. On the other hand, if VM C1-1 and VM C1-2 are placed on compute nodes in MD1, and VM C1-3 and VM C1-4 are placed on compute nodes in MD3, then customer C1 would have twice as much time between the customer's maintenance events/notifications.

In one implementation, the ‘vmClusterMdAvgDistance’ metric varies in value from 0 (indicating that the target VM cluster has VMs in every MD) to the number of MDs available (if all VMs in the target VM cluster are in a single MD). The number thus obtained is then normalized to a common scale of 0 to 1 and used as a quantifiable parameter as a goal.

In general, the greater the vmClusterMdAvgDistance the better (maximizing the time interval between a customer's consecutive maintenance events). Depending on the maintenance policy the customer opts for, the computation of the ‘vmClusterMdAvgDistance’ metric may be conditionally based on the VMs already added to the infrastructure.

The mdVMDensity Metric: Avoiding Maintenance Window Skew

Ideally, during each maintenance window in a maintenance period, approximately the same number of VMs will be drained/migrated. If the compute nodes of some MDs are assigned significantly more VMs than the compute nodes of other MDs, then the cloud platform will experience “maintenance window skew” where the number of VMs affected in some maintenance windows greatly exceeds the number of VMs affected in other maintenance windows.

To avoid maintenance skew, the VM placement algorithm uses a ‘mdVMDensity’ metric. The mdVMDensity metric is defined as the ratio of the number of VMs in a given MD to the total number of VMs on cloud platform. Avoiding maintenance window skew decreases the overall operational cost and the VM migration load for each MD over the compute nodes scheduled for maintenance in their respective notification periods.

### Computing Placement_Context Scores

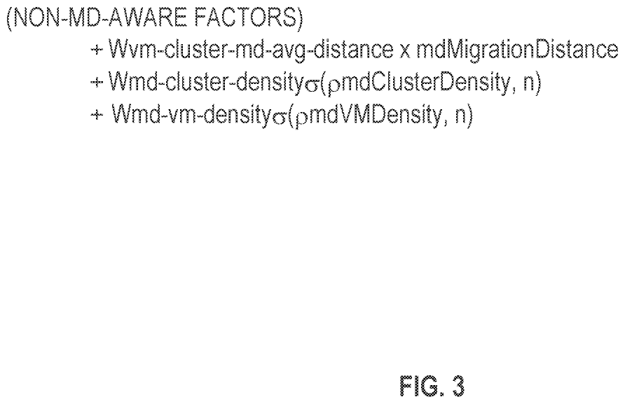

As explained above with respect to FIG. 2, in one implementation, placement module 100 determines the compute node on which to place a target VM by computing a placement_context score for each candidate compute node, and then selecting the compute node with the highest placement_context score. FIG. 3 illustrates an objective function that may be used by placement module 100 for placing a VM in an MD-aware manner.

Referring to FIG. 3, it illustrates an objective function for selecting the compute node for a target VM. The illustrated objective function includes one or more non-MD-aware metrics, and one or more MD-aware metrics. The non-MD-aware metrics may include metrics relating to maximizing resource utilization, maximizing spread among compute-nodes, and minimizing fragmentation. More specifically, the non-MD-aware metrics may include, for example, a metric defined as the weighted average for the standard deviation of a respective resource (CPU, memory, etc.) and optimal resource density. The specific non-MD-aware metrics reflected in the objective function used in the VM-to-compute-node placement logic may vary from implementation to implementation. The MD-aware placement techniques described herein are not limited to any particular set or formulation of non-MD-aware metrics.

In addition to the non-MD-aware metrics, the objective function illustrated in FIG. 3 includes the following MD-aware metrics:
w_{vm-cluster-md-avg-distance}
w_{md-cluster-density}σ(ρ_{mdClusterDensity}, n)
w_{md-vm-density}σ(ρ_{mdVMDensity}, n)

In the illustrated function, w_{vm-cluster-md-avg-distance}×mdMigrationDistance is the term with weight configuration used to maximize the MD distance of the selected set of MDs. More specifically, mdMigrationDistance is a metric that measures the average distance of inter-MDs containing the VMs of the target VM cluster.

The term for md-cluster-density is for minimization of mdClusterDensityDeviation, to spread VMs across a selected set of MDs. Specifically, mdVmClusterDensity is the number of VMs of a cluster in each MD, and is defined for each MD. This factor is used to distribute the VMs across the MDs for high availability and to prevent skews.

The term md-vm-density configuration is to distribute the VMs of all clusters across the MDs by minimizing the VM density of all clusters across the MDs. In particular, mdVMDensity is the number of VMs of all the clusters in each MD. Use of this term prevents skewed distribution of VMs for all clusters on a fixed set of MDs.

Computing, for each VM/compute-node combination, the metrics described above allows placement module 100 to compute a set of values whose deviation or average can be taken as an accurate measure of the issue at hand, and thereby can be included as a part of the goal by taking the weighted average over the previous goal. As each policy and VM Cluster's VM addition are interdependent and can act as a goal, the placement module may filter the compute nodes in the relevant sample space for every request, before goal optimization.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

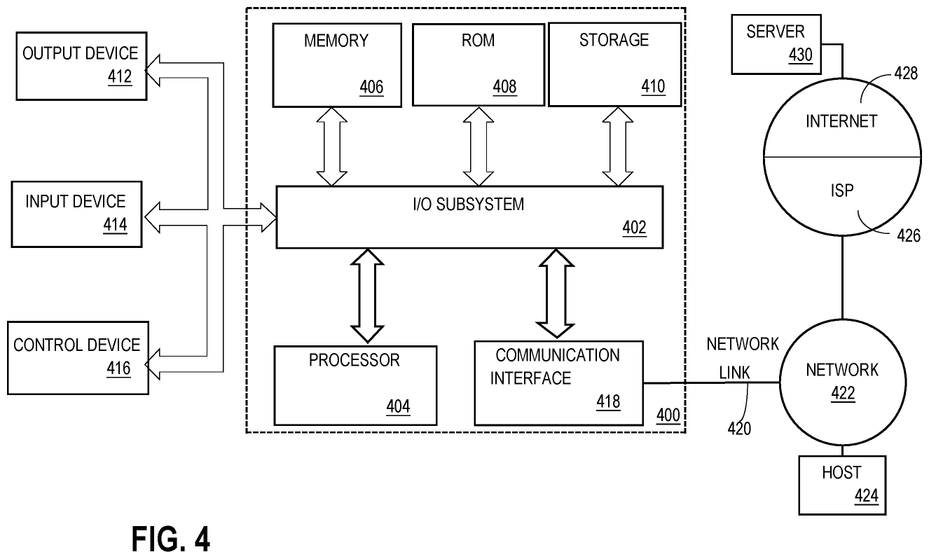

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (Saas), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
partitioning a population of compute nodes of a cloud platform into maintenance domains (MDs);
wherein each compute node in the population of compute nodes belongs to exactly one of the MDs;
wherein maintenance is performed for the cloud platform using rolling maintenance based on the MDs;
for a target virtual machine, determining a compute-node on which to place the target virtual machine by:
for the target virtual machine, determining, for each compute-node in a set of candidate compute nodes, a placement_context score based on a plurality of metrics;
wherein each metric of the plurality of metrics corresponds to a goal;
wherein the plurality of metrics includes at least one MD-aware metric; and
selecting a particular compute-node for placement of the target virtual machine based on the placement_context scores determined for the target virtual machine;
placing the VM on the particular compute-node;
wherein the method is performed by one or more computing devices.

2. The method of claim 1 wherein the at least one MD-aware metric includes a metric associated with a goal of increasing availability, during rolling maintenance, of virtual machines that belong a target virtual machine cluster, wherein the target virtual machine cluster is a virtual machine cluster to which the target virtual machine belongs.

3. The method of claim 1 wherein the at least one MD-aware metric includes a metric associated with a goal of avoiding too-closely-timed maintenance events for virtual machines that belong a target virtual machine cluster, wherein the target virtual machine cluster is a virtual machine cluster to which the target virtual machine belongs.

4. The method of claim 1 wherein the at least one MD-aware metric includes a metric associated with a goal of evenly spreading virtual machines that are hosted by the cloud platform among the MDs.

5. The method of claim 1 further comprising determining the set of candidate nodes for the target virtual machine by filtering the population of compute nodes based on constraints.

6. The method of claim 5 wherein in constraints used to filter the population of compute nodes include a particular constraint that specifies a maintenance policy associated with a target virtual machine cluster, wherein the target virtual machine cluster is a virtual machine cluster to which the target virtual machine belongs.

7. The method of claim 6 further comprising receiving input, for a customer associated with the target virtual machine cluster, that indicates the maintenance policy to associate with the target virtual machine cluster.

8. The method of claim 7 wherein the input indicates one of:
a first maintenance policy that indicates all virtual machines in the target virtual machine cluster are to be placed in a single MD;
a second maintenance policy that indicates all virtual machines in the target virtual machine cluster are to be split between two MDs; or
a third maintenance policy that indicates all virtual machines in the target virtual machine cluster are to be spread among as many MDs as possible.

9. The method of claim 1 wherein the plurality of metrics includes one or more non-MD-aware metrics, wherein the one or more non-MD-aware metrics include at least one of:
a metric relating to maximizing resource utilization,
a metric relating to maximizing spread among compute-nodes, and
metric relating to minimizing fragmentation.

10. One or more non-transitory computer-readable media storing instructions which, when executed by one or more computing devices, cause:
partitioning a population of compute nodes of a cloud platform into maintenance domains (MDs);
wherein each compute node in the population of compute nodes belongs to exactly one of the MDs;
wherein maintenance is performed for the cloud platform using rolling maintenance based on the MDs;
for a target virtual machine, determining a compute-node on which to place the target virtual machine by:
for the target virtual machine, determining, for each compute-node in a set of candidate compute nodes, a placement_context score based on a plurality of metrics;
wherein each metric of the plurality of metrics corresponds to a goal;
wherein the plurality of metrics includes at least one MD-aware metric; and
selecting a particular compute-node for placement of the target virtual machine based on the placement_context scores determined for the target virtual machine; and
placing the VM on the particular compute-node.

11. The one or more non-transitory computer-readable media of claim 10 wherein the at least one MD-aware metric includes a metric associated with a goal of increasing availability, during rolling maintenance, of virtual machines that belong a target virtual machine cluster, wherein the target virtual machine cluster is a virtual machine cluster to which the target virtual machine belongs.

12. The one or more non-transitory computer-readable media of claim 10 wherein the at least one MD-aware metric includes a metric associated with a goal of avoiding too-closely-timed maintenance events for virtual machines that belong a target virtual machine cluster, wherein the target virtual machine cluster is a virtual machine cluster to which the target virtual machine belongs.

13. The one or more non-transitory computer-readable media of claim 10 wherein the at least one MD-aware metric includes a metric associated with a goal of evenly spreading virtual machines that are hosted by the cloud platform among the MDs.

14. The one or more non-transitory computer-readable media of claim 10 wherein the instructions include instructions for determining the set of candidate nodes for the target virtual machine by filtering the population of compute nodes based on constraints.

15. The one or more non-transitory computer-readable media of claim 14 wherein the constraints used to filter the population of compute nodes include a particular constraint that specifies a maintenance policy associated with a target virtual machine cluster, wherein the target virtual machine cluster is a virtual machine cluster to which the target virtual machine belongs.

16. The one or more non-transitory computer-readable media of claim 15 wherein the instructions include instructions for receiving input, for a customer associated with the target virtual machine cluster, that indicates the maintenance policy to associate with the target virtual machine cluster.

17. The one or more non-transitory computer-readable media of claim 16 wherein the input indicates one of:
a first maintenance policy that indicates all virtual machines in the target virtual machine cluster are to be placed in a single MD;
a second maintenance policy that indicates all virtual machines in the target virtual machine cluster are to be split between two MDs; or
a third maintenance policy that indicates all virtual machines in the target virtual machine cluster are to be spread among as many MDs as possible.

18. The one or more non-transitory computer-readable media of claim 10 wherein the plurality of metrics includes one or more non-MD-aware metrics, wherein the one or more non-MD-aware metrics include at least one of:
a metric relating to maximizing resource utilization,
a metric relating to maximizing spread among compute-nodes, and
metric relating to minimizing fragmentation.
